(19) United States
(12) Patent Application Publication
(10) Pub. No.: US 2016/0080874 A1
(43) Pub. Date: Mar. 17, 2016

(54) GAZE-BASED AUDIO DIRECTION

(71) Applicant: Scott Fullam, Palo Alto, CA (US)

(72) Inventor: Scott Fullam, Palo Alto, CA (US)

(21) Appl. No.: 14/487,940

(22) Filed: Sep. 16, 2014

(51) Int. Cl. H04R 25/00; G02B 27/01; G06F 3/01

(52) U.S. Cl. CPC H04R 25/407; G06F 3/013; G02B 27/017

(57) ABSTRACT

A hearing assistance system includes an eye tracker to determine a gaze target of a user, a microphone array, a speaker, and an audio conditioner to output assistive audio via the speaker. The assistive audio is processed from microphone array output to emphasize sounds that originate near the gaze target determined by the eye tracker.

### BACKGROUND

Multiple sources of sound present in an environment may be heard by a user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments for a hearing assistance system are provided. In one example, a hearing assistance system comprises an eye tracker to determine a gaze target of a user, a microphone array, a speaker, and an audio conditioner to output assistive audio via the speaker. The assistive audio is processed from microphone array output to emphasize sounds that originate near the gaze target determined by the eye tracker.

### BRIEF DESCRIPTION OF THE DRAWINGS

FIG. 1 schematically shows an example assistive audio usage environment.

FIG. 2 schematically shows example processing of sounds to create assistive audio output.

FIG. 3 is a flow chart illustrating a method for processing audio signals based on a gaze target of a user.

FIG. 4 schematically shows an example head-worn device.

FIG. 5 is a schematic computing system.

### DETAILED DESCRIPTION

An environment may include more than one source of sound, and this may cause a listener difficulty when attempting to focus on only one of the sound sources. For example, if two people are attempting to carry on a conversation in a noisy environment, such as in a room with a television playing, it may be difficult for one or both of the people to hear the conversation.

According to embodiments disclosed herein, the primary attention target of a user may be determined using gaze tracking, and assistive audio may be provided to the user in order to emphasize sounds originating near the target, while deemphasizing sounds originating away from the target. The assistive audio may include processed output from a microphone array. For example, beamforming may be performed on the output from the microphone array to produce a beam of sound having a primary direction biased in the direction of the target. The assistive audio may be presented to the user via one or more speakers.

In some examples, the gaze tracking system, microphone array, and/or speakers may be located on separate devices. For example, the gaze tracking system may be part of a laptop computer, the microphone array may be part of an entertainment system, and the speaker may be a personal headphone set associated with a mobile computing device. However, by separating the components of the hearing assistance system, additional power consumption may result from the transfer of data among the system components, additional processing power may be needed to resolve potential orientation differences between the microphone array and the gaze tracking system, etc. Further, such a configuration limits the environments in which such assistive audio may be provided.

Thus, to provide the microphone array and gaze tracking system in fixed positions relative to each other, as well as increase the portability of the hearing assistance system, the hearing assistance system may be mounted on a wearable platform, such as a head-worn device. In one non-limiting example, the head-worn device may comprise a head-mounted display (HMD) device including a see-through display configured for presenting augmented realities to a user.

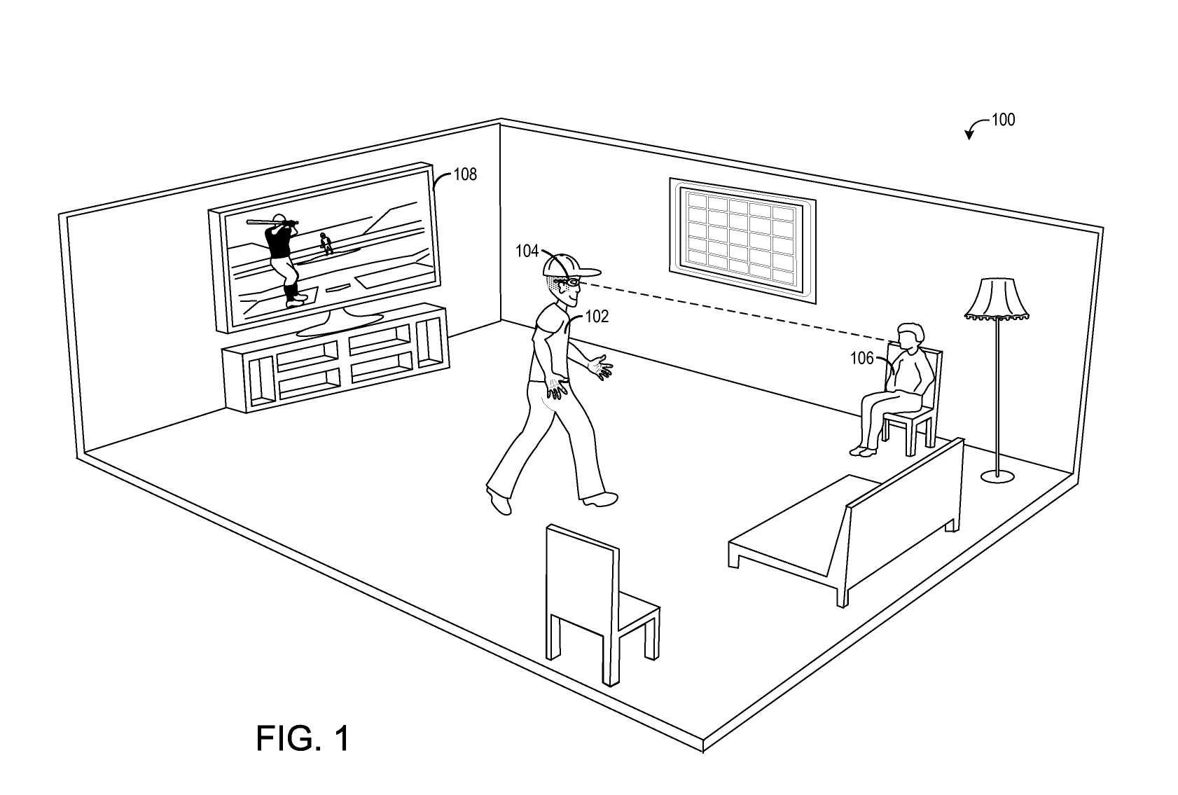

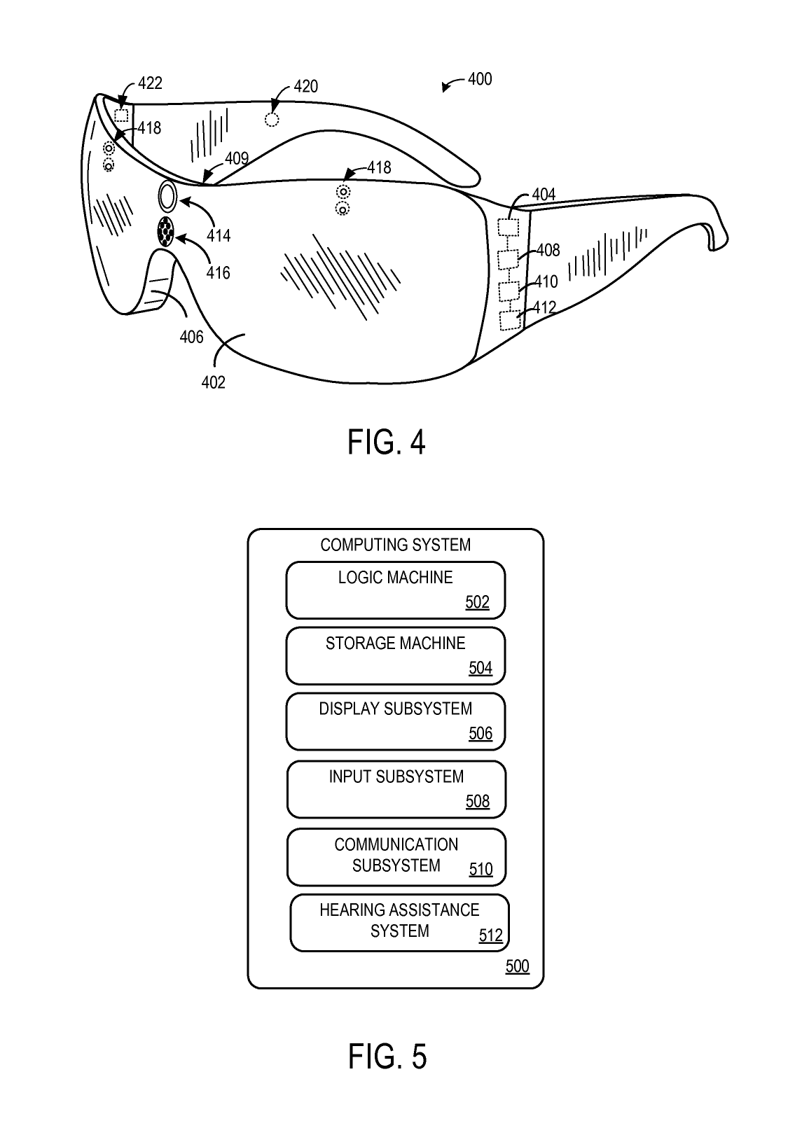

Turning to FIG. 1, an example hearing assistance environment 100 is presented. Environment 100 includes a first user 102 wearing a hearing assistance system 104 included as part of a head-worn device. As will be explained in more detail below with respect to FIGS. 4-5, the hearing assistance system 104 may include a gaze tracking system to determine a gaze target of a user, a microphone array to acquire sound from within the environment 100, at least one speaker to present audio output to the user, and an audio conditioner to process output from the microphone array based on the determined gaze target.

The hearing assistance system 104 may be used to present assistive audio to first user 102 that emphasizes sounds originating near a gaze target of first user 102, and deemphasize sounds originating away from the gaze target. As shown in FIG. 1, first user 102 is looking at second user 106. The hearing assistance system 104 may detect that second user 106 is the gaze target of first user 102, and the audio conditioner may perform beamforming and/or other signal manipulations on the signals output by the microphone array of the hearing assistance system 104 to emphasize sounds originating near second user 106, e.g., the voice of second user 106. Further, the beamforming performed by the audio conditioner of the hearing assistance system 104 may deemphasize sounds originating away from second user 106, such as sounds output by television 108.

The gaze tracking system may utilize a suitable gaze tracking technology to determine the gaze target of the user. In one example, the gaze tracker may include one or more eye-tracking sensors, such as inward-facing image sensors, to track the orientation of the user's eyes as well as the convergence point (e.g., focal length) of the user's gaze. Other gaze determination technology may be used, such as head orientation, eye muscle activity, or other suitable technology.

The microphone array may comprise two or more microphones. The microphones may be omni-directional or directional. Each microphone in the array may be orientated in a parallel direction, or one or more of the microphones may be orientated in a different direction from one or more other microphones in the array. The microphones in the array may be located proximate each other (with at least some distance separating each microphone), or the microphones may be located distal each other. Further, in some examples, the hearing assistance system 104 may be configured to receive signals from one or more microphones located remotely from the hearing assistance system 104 (e.g., located remotely from the head-worn device). For example, one or more microphones present in the environment that the user is residing (such as microphones located on an external computing device) may be configured to send signals to the hearing assistance system 104, and the audio conditioner of the hearing assistance system may utilize the remote signals, in addition to or in alternative of the signals received from a microphone array on the hearing assistance system, to provide assistive audio to the user.

The one or more speakers may be positioned proximate the user's ears. In one example, such as the example illustrated in FIG. 1, two speakers may be present, one near each ear of the user, and each speaker may be located outside of each respective ear. That is, in the example of FIG. 1, the speakers are not positioned to perform passive and/or active noise cancellation and instead all ambient noise that would normally reach the user's ears is passed to the user, along with the assistive audio. However, in some embodiments, the speakers may be positioned differently to enable at least some cancellation of ambient noise, such as positioned partially within each ear of the user. Further, in some examples, active noise cancellation may be performed in addition to the processing provided by the audio conditioner. Each of the two speakers may provide similar or different audio output. More or fewer speakers may be present in other examples.

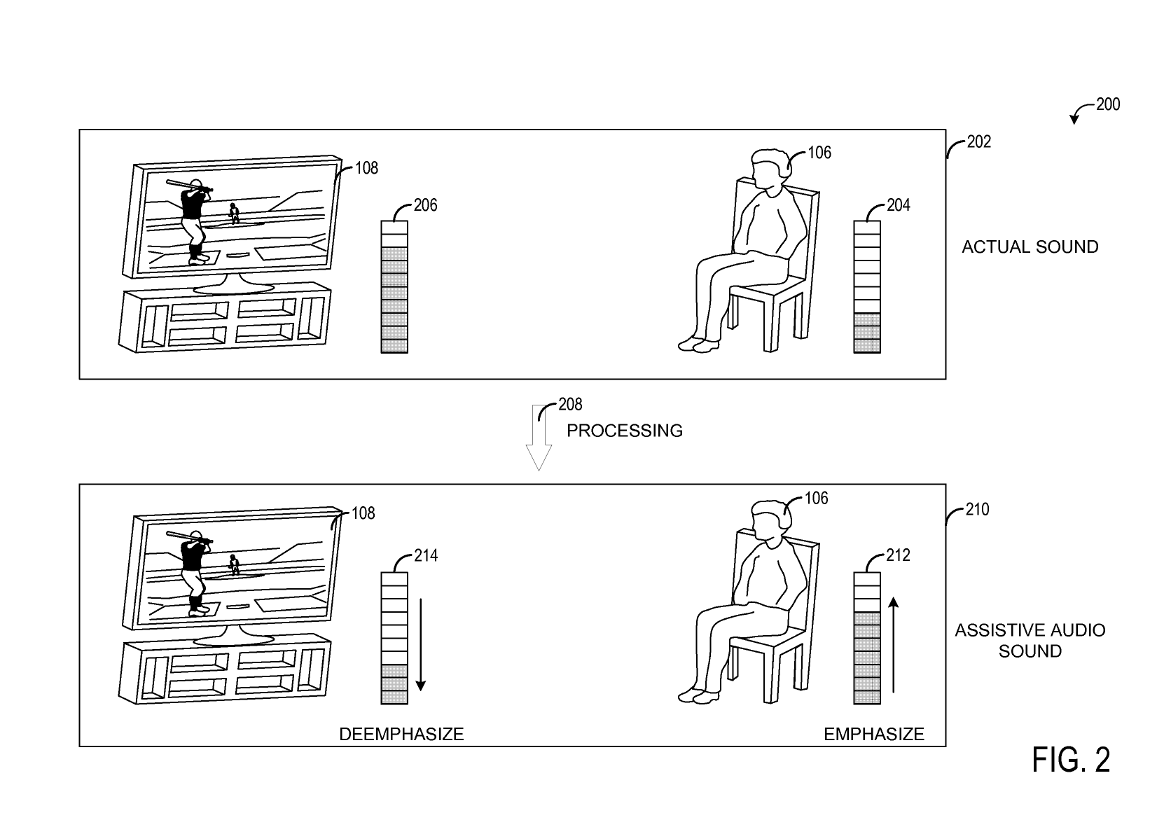

FIG. 2 is a diagram 200 graphically representing the processing performed by the audio conditioner in order to emphasize some sounds while deemphasizing others. Block 202 represents the actual sound produced by elements in the environment 100 of FIG. 1, specifically by second user 106 and television 108. In one example, depicted by sound bar 204, second user 106 is producing relatively quiet sounds, such as a sound level of three on a scale of ten. In contrast, the television is producing relatively loud sounds, as represented by sound bar 206, such as a sound level of eight on a scale of ten.

The audio conditioner performs processing 208 on the sound picked up by the microphone array in order to produce the assistive audio sound depicted in block 210. As shown by sound bar 212, the sound from second user 106 has been emphasized such that it is delivered by the speakers of the hearing assistance system at a sound level of seven. As shown by sound bar 214, the sound from television 108 has been deemphasized, such that it is delivered by the speakers of the hearing assistance system at a sound level of three. In this way, the processing performed by the audio conditioner may amplify the sounds originating at the gaze target and attenuate the sounds originating away from the gaze target, in order to allow the user to preferentially hear the sounds originating at the gaze target (e.g., the voice of second user 106).

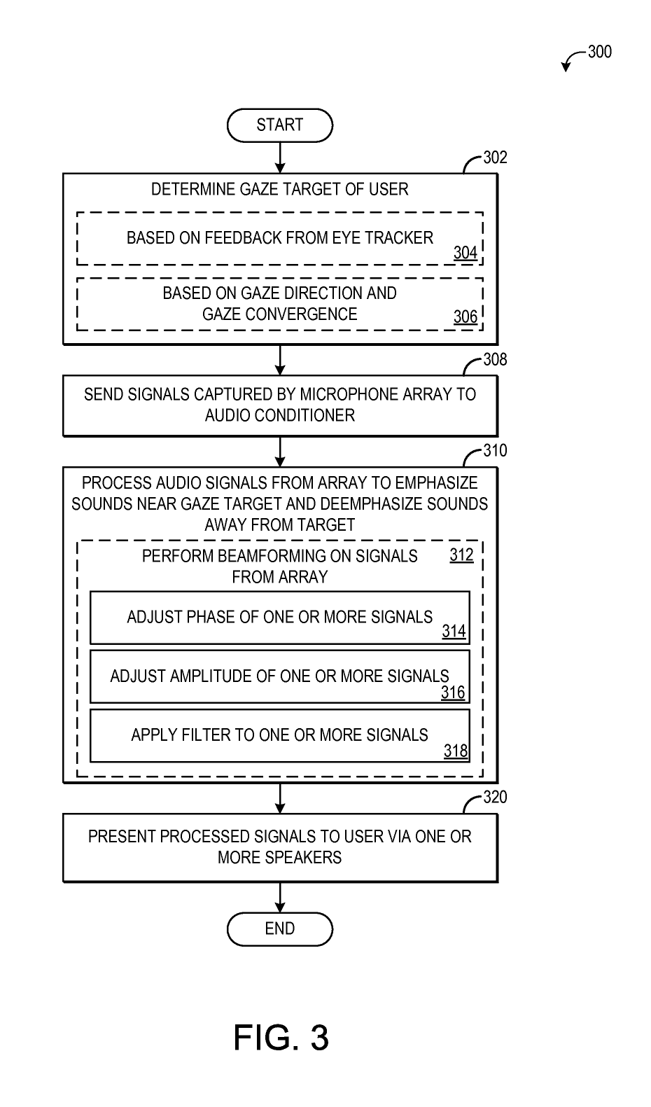

FIG. 3 is a flow chart illustrating a method 300 for producing assistive audio output. Method 300 may be performed by a hearing assistance system including an eye tracker, microphone array, at least one speaker, and an audio conditioner. In one example, the audio conditioner may be part of a controller configured to execute the method 300. The hearing assistance system may be included in a head-worn device, such as the HMD device illustrated in FIG. 4 and described in more detail below.

At 302, method 300 includes determining a gaze target of a user. The gaze target may be determined based on feedback from an eye tracker, as indicated at 304. The eye tracker may include one or more image sensors to track a user eye orientation. The gaze target may be determined based on the gaze direction and convergence point of the gaze of the user, as indicated at 306.

At 308, the signals output by the microphone array (e.g., ambient audio is picked up with the microphone array) is sent to the audio conditioner. The microphone array may capture sound from all directions (e.g., be omni-directional) or may capture sounds from one or more directions preferentially (e.g., be directional).

At 310, the signals output from the microphone array are processed by the audio conditioner to emphasize sounds originating near the gaze target and deemphasize sounds originating away from the gaze target. As used herein, sounds originating near the gaze target may include sounds within a threshold range of the gaze target. The threshold range may vary depending on the size of the gaze target, type of sounds originating at the gaze target, presence of other sounds in the environment, or other factors. In some examples, sounds originating near the gaze target may include only sounds being output by the gaze target, while in other examples, sounds originating near the gaze target may include all sounds within the threshold distance from the gaze target. Sounds originating away from the gaze target may include all sounds not considered to be originating near the gaze target.

The processing may include performing beamforming on the signals output by the microphone array, as indicated at 312. However, other audio processing is possible, such as mechanically moving the orientation of one or more microphones of the array to preferentially capture sound originating at the gaze target.

Beamforming includes processing one or more signals from the microphone array in order to produce a beam of sound biased in the direction of the gaze target. Beamforming may act to amplify some signals and attenuate other signals. The attenuation may include fully canceling some signals in some examples. The beamforming may include adjusting the phase of one or more of the signals output by the microphone array, as indicated at 314. The phase may be adjusted by an amount determined based on the relative distance and/or direction of the gaze target from the individual microphones of the microphone array. By adjusting the phase of the one or more signals, interference with the one or more signals may occur, attenuating the one or more signals.

The beamforming may additionally or alternatively include adjusting the amplitude of one or more signals output by the microphone array, as indicated at 316. The amplitude may be adjusted by an amount determined based on the relative distance and/or direction of the gaze target from the individual microphones of the microphone array. By adjusting the amplitude, the volume of the signals eventually output via the speakers may be adjusted, relative to each other. The amplitude adjustment may act to amplify or attenuate a particular signal.

The beamforming may additionally or alternatively include applying a filter to the one or more signals output by the microphone array, as indicated at 318. The type of filter applied and/or the coefficients of the filter may be determined based on the relative distance and/or direction of the gaze target from the individual microphones of the microphone array. A low-pass filter, high-pass filter, or other suitable filter may be used. In one example, the signals originating away from the gaze target may be subject to a higher amount of filtering than the signals originating near the gaze target.

At 320, the processed signals are presented to the user via the one or more speakers.

With reference now to FIG. 4 one example of a see-through display/HMD device 400 in the form of a pair of wearable glasses with a transparent display 402 is provided. It will be appreciated that in other examples, the HMD device 400 may take other suitable forms in which a transparent, semi-transparent, and/or non-transparent display is supported in front of a viewer's eye or eyes. It will also be appreciated that the head-worn device housing the hearing assistance system 104 shown in FIG. 1 may take the form of the HMD device 400, as described in more detail below, or any other suitable HMD device.

The HMD device 400 includes a display system 404 and transparent display 402 that enables images such as holographic objects to be delivered to the eyes of a wearer of the HMD. The transparent display 402 may be configured to visually augment an appearance of a physical environment to a wearer viewing the physical environment through the transparent display. For example, the appearance of the physical environment may be augmented by graphical content (e.g., one or more pixels each having a respective color and brightness) that is presented via the transparent display 402 to create an augmented reality environment. As another example, transparent display 402 may be configured to render a fully opaque virtual environment.

The transparent display 402 may also be configured to enable a user to view a physical, real-world object in the physical environment through one or more partially transparent pixels that are displaying a virtual object representation. As shown in FIG. 6, in one example the transparent display 402 may include image-producing elements located within optics 406 (such as, for example, a see-through Organic Light-Emitting Diode (OLED) display). As another example, the transparent display 402 may include a light modulator on an edge of the optics 406. In this example the optics 406 may serve as a light guide for delivering light from the light modulator to the eyes of a user. Such a light guide may enable a user to perceive a 3D holographic image located within the physical environment that the user is viewing, while also allowing the user to view physical objects in the physical environment, thus creating an augmented reality environment.

The HMD device 400 may also include various sensors and related systems. For example, the HMD device 400 may include a gaze tracking system 408 that includes one or more image sensors configured to acquire image data of a user's eyes. Provided the user has consented to the acquisition and use of this information, the gaze tracking system 408 may use this information to track a position and/or movement of the user's eyes.

In one example, the gaze tracking system 408 includes a gaze detection subsystem configured to detect a direction of gaze of each eye of a user. The gaze detection subsystem may be configured to determine gaze directions of each of a user's eyes in any suitable manner. For example, the gaze detection subsystem may comprise one or more light sources, such as infrared light sources, configured to cause a glint of light to reflect from the cornea of each eye of a user. One or more image sensors may then be configured to capture an image of the user's eyes.

Images of the glints and of the pupils as determined from image data gathered from the image sensors may be used to determine an optical axis of each eye. Using this information, the gaze tracking system 408 may then determine a direction the user is gazing. The gaze tracking system 408 may additionally or alternatively determine at what physical or virtual object the user is gazing. Such gaze tracking data may then be provided to the HMD device 400.

It will also be understood that the gaze tracking system 408 may have any suitable number and arrangement of light sources and image sensors. For example and with reference to FIG. 4, the gaze tracking system 408 of the HMD device 400 may utilize at least one inward-facing sensor 409.

The HMD device 400 may also include sensor systems that receive physical environment data from the physical environment. As examples, outward-facing cameras, depth cameras, and microphones may be used.

The HMD device may also include sensor systems for tracking an orientation of the HMD device in an environment. For example, the HMD device 400 may include a head tracking system 410 that utilizes one or more motion sensors, such as motion sensors 412 on HMD device 400, to capture head pose data and thereby enable position tracking, direction and orientation sensing, and/or motion detection of the user's head.

Head tracking system 410 may also support other suitable positioning techniques, such as GPS or other global navigation systems. Further, while specific examples of position sensor systems have been described, it will be appreciated that any other suitable position sensor systems may be used. For example, head pose and/or movement data may be determined based on sensor information from any combination of sensors mounted on the wearer and/or external to the wearer including, but not limited to, any number of gyroscopes, accelerometers, inertial measurement units (IMUs), GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

In some examples the HMD device 400 may also include an optical sensor system that utilizes one or more outward-facing sensors, such as optical sensor 414 on HMD device 400, to capture image data. The outward-facing sensor(s) may detect movements within its field of view, such as gesture-based inputs or other movements performed by a user or by a person or physical object within the field of view. The outward-facing sensor(s) may capture 2D image information and/or depth information from the physical environment and physical objects within the environment. For example, the outward-facing sensor(s) may include a depth camera, a visible light camera, an infrared light camera, and/or a position tracking camera.

The optical sensor system may include a depth tracking system that generates depth tracking data via one or more depth cameras. In one example, each depth camera may include left and right cameras of a stereoscopic vision system. Time-resolved images from one or more of these depth cameras may be registered to each other and/or to images from another optical sensor such as a visible spectrum camera, and may be combined to yield depth-resolved video.

In other examples a structured light depth camera may be configured to project a structured infrared illumination, and to image the illumination reflected from a scene onto which the illumination is projected. A depth map of the scene may be constructed based on spacings between adjacent features in the various regions of an imaged scene. In still other examples, a depth camera may take the form of a time-of-flight depth camera configured to project a pulsed infrared illumination onto a scene and detect the illumination reflected from the scene. For example, illumination may be provided by an infrared light source 416. It will be appreciated that any other suitable depth camera may be used within the scope of the present disclosure.

The outward-facing sensor(s) may capture images of the physical environment in which a user is situated. With respect to the HMD device 400, in one example a mixed reality display program may include a 3D modeling system that uses such captured images to generate a virtual environment that models the physical environment surrounding the user.

The HMD device 400 may also include a microphone system that includes one or more microphones, such as microphone array 418 on HMD device 400, that capture audio data. In the example of FIG. 4, the microphone array 418 comprises four microphones, two near each optic of the HMD device. For example, two of the microphones of array 418 may be positioned proximate a left eyebrow of a user, and two of the microphones of array 418 may positioned proximate a right eyebrow of the user, when the HMD device is worn by the user. Further, the microphone array 418 may include inward and/or outward-facing microphones. In the example of FIG. 4, the array 418 includes two inward-facing microphones aimed to capture sounds originating from the wearer of the HMD device (e.g., capture voice output) and two outward-facing microphones. The two inward-facing microphones may be positioned together (e.g., near the same optic) or the two inward-facing microphones may be positioned apart (e.g., one near each optic, as illustrated). Similarly, the outward-facing microphones may be positioned together or apart. Further, the two microphones on each lens may be arranged in any suitable configuration, such as stacked vertically (as shown) or arrayed horizontally.

It is to be understood that the above configuration of the microphone array 418 is non-limiting, as other configurations are possible. For example, rather than having four microphones, the array may include a different number of microphones, such as two, three, five, six, eight, or other desired configuration. However, to form an array capable of having its output processed in the manner described herein, at least two microphones may be present. Further, the microphones of the array may be positioned proximate each other, distal each other, in groups, or other configuration, as long as at least a small amount of separation between each microphone is present. In general, more microphones may allow for more accurate beamforming but may be more computationally, spatially, and cost expensive.

In some examples, audio may be presented to the user via one or more speakers, such as speaker 420 on the HMD device 400.

The HMD device 400 may also include a controller, such as controller 422 on the HMD device 400. The controller may include a logic machine and a storage machine, as discussed in more detail below with respect to FIG. 5, that are in communication with the various sensors and systems of the HMD device and display. In one example, the storage machine may include instructions that are executable by the logic machine to receive and process sensor data from the sensors as described herein.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows a non-limiting embodiment of a computing system 500 that can enact one or more of the methods and processes described above. Computing system 500 is one non-limiting example of the head-worn device of FIG. 1 and the HMD device 400 of FIG. 4. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices.

Computing system 500 includes a logic machine 502 and a storage machine 504. Computing system 500 may optionally include a display subsystem 506, input subsystem 508, communication subsystem 510, hearing assistance system 512, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 implemented to perform a particular function. In some cases, a module, program, or engine may be instantiated via logic machine 502 executing instructions held by storage machine 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

Computing system 500 may also include a hearing assistance system 512. The hearing assistance system 512 includes an eye tracker (which may include sensors described above as part of the input subsystem), microphone array (which may also be included as part of the input subsystem described above), one or more speakers for outputting audio signals, and an audio conditioner. As explained previously, the audio conditioner may process signals received from the microphone array based on a gaze target determined based on feedback from the eye tracker.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A head-mounted display device, comprising:
a see-through display;
an eye tracker to determine a gaze target of a user;
a microphone array comprising two inward-facing microphones aimed to capture sounds originating from the user and two outward-facing microphones;
a speaker; and
an audio conditioner to output assistive audio via the speaker, the assistive audio processed from microphone array output via beamforming to emphasize sounds that originate near the gaze target determined by the eye tracker.

2. A hearing assistance system, comprising:
an eye tracker to determine a gaze target of a user;
a microphone array;
a speaker; and
an audio conditioner to output assistive audio via the speaker, the assistive audio processed from microphone array output to emphasize sounds that originate near the gaze target determined by the eye tracker.

3. The hearing assistance system of claim 2, wherein the audio conditioner processes the microphone array output to deemphasizes sounds that originate away from the gaze target determined by the eye tracker.

4. The hearing assistance system of claim 2, wherein the eye tracker comprises one or more image sensors positioned to track an eye orientation of the user.

5. The hearing assistance system of claim 2, wherein the eye tracker determines the gaze target based on a determined direction and convergence point of a gaze of the user.

6. The hearing assistance system of claim 2, wherein the audio conditioner is configured to perform beamforming on the microphone array output in order to emphasize sounds originating near the gaze target and deemphasize sounds originating away from the gaze target.

7. The hearing assistance system of claim 6, wherein the audio conditioner performs the beamforming by adjusting a phase of one or more signals of the microphone array output.

8. The hearing assistance system of claim 6, wherein the audio conditioner performs the beamforming by adjusting an amplitude of one or more signals of the microphone array output.

9. The hearing assistance system of claim 6, wherein the audio conditioner performs the beamforming by applying a filter to one or more signals of the microphone array output.

10. The hearing assistance system of claim 2, wherein the array of microphones comprises four microphones.

11. The hearing assistance system of claim 2, wherein the eye tracker and microphone array are mounted on a wearable platform in fixed positions relative to one another.

12. The hearing assistance system of claim 11, wherein the wearable platform is a head-worn device.

13. The hearing assistance system of claim 11, wherein the microphone array comprises two inward-facing microphones aimed to capture sounds originating from the user and two outward-facing microphones.

14. A device, comprising:
one or more eye-tracking sensors;
a microphone array comprising at least two microphones;
at least one speaker; and
a controller to:
determine a gaze target of a user based on information captured by the one or more eye-tracking sensors; and
perform beamforming on one or more signals output by the microphone array based on the gaze target in order to modulate audio output by the at least one speaker to emphasize sound originating near the gaze target.

15. The device of claim 14, wherein the device is a head-worn device.

16. The device of claim 15, wherein the microphone array comprises two inward-facing microphones aimed to capture sounds originating from the user and two outward-facing microphones.

17. The device of claim 16, wherein the two inward-facing microphones and two outward-facing microphones are positioned on the head-worn device such that a first inward-facing microphone and a first outward-facing microphone are positioned proximate a right eyebrow of the user and a second inward-facing microphone and a second outward-facing microphone are positioned proximate a left eyebrow of the user when the head-worn device is worn by the user.

18. The device of claim 14, wherein the controller performs the beamforming by adjusting a phase and/or amplitude of the one or more signals based on the gaze target.

19. The device of claim 14, wherein the controller performs the beamforming by applying a filter to the one or more signals based on the gaze target.

20. The device of claim 14, wherein the controller performs the beamforming on one or more signals based on a direction and/or distance of the gaze target from the microphone array.
